(19) United States
(12) Patent Application Publication
(10) Pub. No.: US 2015/0017333 A1
(43) Pub. Date: Jan. 15, 2015

(54) RESIN SPREAD DEVICE AND METHOD OF SPREADING RESIN

(71) Applicant: Samsung Display Co., Ltd., Yongin-City (KR)

(72) Inventor: Young-Sik KIM, Cheonan-si (KR)

(21) Appl. No.: 14/222,965

(22) Filed: Mar. 24, 2014

(30) Foreign Application Priority Data
Jul. 15, 2013 (KR) 10-2013-0082773

(51) Int. Cl. B05C 1/00

(52) U.S. Cl. CPC B05C 1/00
USPC 427/356; 118/100

(57) ABSTRACT

A resin spread device includes a substrate, a first member, a resin and a second member. The first member is disposed on the substrate, the first member includes a first region, a second region and a third region, the first region and the third region surround the second region, a plurality of rectangular openings is disposed on the second region and the first member surrounds the openings. The resin is disposed in the openings. The second member is disposed on the first region, and is transported from the first region through the second region to the third region.

### CLAIM PRIORITY

This application makes reference to, incorporates the same herein, and claims all benefits accruing under 35 U.S.C. §119 from an application earlier filed in the Korean Intellectual Property Office on 15 Jul. 2013 and there duly assigned Serial No. 10-2013-0082773.

### BACKGROUND OF THE INVENTION

1. Field of the Invention

Example embodiments of the inventive concept generally relate to a spread device used in, but not limited to, the spreading of a resin.

2. Description of the Related Art

A resin spread device spreads a resin in a predetermined region.

The above information disclosed in this Related Art section is only for enhancement of understanding of the background of the invention and therefore it may contain information that does not form the prior art that is already known to a person of ordinary skill in the art.

### SUMMARY OF THE INVENTION

Example embodiments provide a resin spread device capable of spreading the resin that is uniform.

Example embodiments provide a method of spreading a resin capable of spreading the resin at a uniform thickness.

According to one aspect of example embodiments, a resin spread device includes a substrate, a first member, a resin and a second member. The first member is disposed on the substrate, the first member includes a first region, a second region and a third region, the first region and the third region surround the second region, a plurality of rectangular openings is disposed on the second region and the first member surrounds the openings. The resin is disposed in the openings. The second member is disposed on the first region, and is transported from the first region through the second region to the third region.

In example embodiments, a length of each opening in an X-direction may be shorter than a length of the opening in a Y-direction, and the X-direction and the Y-direction may be substantially perpendicular.

In example embodiment, the rectangular openings may include a mesh structure.

In example embodiment, a lower surface of the mesh structure may include a structure makes contact with the substrate.

In example embodiment, a lower surface of the mesh structure may be spaced apart from the substrate.

In example embodiment, an upper surface of the resin disposed in the opening may be inclined with respect to the substrate.

In example embodiment, an upper surface of the resin may be higher in a passing direction of the second member.

According to another aspect of example embodiments, a method of spreading a resin is provided as follows. A first member is disposed on a substrate. A second member and a resin are disposed on a first region of the first member. The resin is filled in openings of the first member while the second member and the resin may be transported from the first region through a second region of the first member to a third region of the first member. The first member and the second member are removed to cure the resin.

In example embodiment, a length of each opening in an X-direction may be shorter than a length of the opening in a Y-direction, and the X-direction and the Y-direction may be substantially perpendicular.

In example embodiment, a plurality of rectangular openings may include a mesh structure.

In example embodiment, an upper surface of the resin in the opening may incline with respect to the substrate.

In example embodiments, the upper surface of the resin is higher in a passing direction of the second member.

According to one aspect of example embodiments, a resin spread device includes a substrate, a third member, a resin, a second member. The third member is disposed on the substrate, the third member includes a first region, a second region and a third region, the first region and the third region surrounds the second region, the third member includes an opening disposed in the second region, the third member surrounds the opening, and a height of the third member in the first region is different from a height of the third member in the third region. The resin is disposed in the opening. The second member is disposed in the first region of the third member, and is transported from the first region through the second region to the third region.

In example embodiment, a thickness of the third member in the first region may be thicker than a thickness of the third member in the third region.

In example embodiments, the second region of the third member may include a planar surface and an inclined surface.

In example embodiments, a thickness of the planar surface and the thickness of the third member in the first region may be substantially the same, and the inclined surface may connect the planar surface to the third member in the third region.

According to one aspect of example embodiments, a resin spread device includes a substrate, a fourth member, a resin and a second member. The fourth member is disposed on the substrate, the fourth member includes a first region, a second region and a third region, the first region and the third region surrounds the second region, the fourth member includes an opening disposed on the second region, and the fourth member surrounds the opening. The resin is disposed in the opening. The second member is disposed in the first region, the second member is transported from the first region through the second region to the third region.

In example embodiments, the resin may include a low viscosity.

In example embodiments, an upper surface of the resin including the low viscosity may be flatted by a gravity.

In example embodiments, the first region, the second region and the third region may be separate distinct regions, the first region may be immediately adjacent to the second region and the second region may be immediately adjacent to the third region, the second region may be between the first and second regions, and no intervening regions or structures may exist between the first, second and third regions.

According to the resin spread device of the present invention, the resin may be spread at a uniform thickness.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view illustrating a resin spread device in accordance with example embodiments of the present invention;

FIG. 2 is a plane view illustrating the resin spread device having a stencil mask of FIG. 1;

FIG. 3 is a cross-sectional view illustrating a stencil mask taken along a line IV-IV′ in FIG. 2;

FIGS. 4A to 4D are a cross-sectional views for describing a method of spreading a resin using the resin spread device of FIG. 1;

FIG. 5 is a cross-sectional view illustrating a resin spread device in accordance with example embodiments of the present invention;

FIG. 6 is a cross-sectional view illustrating a resin spread device in accordance with example embodiments of the present invention.

FIG. 7 is a plane view illustrating the resin spread device having a stencil mask of FIG. 6;

FIG. 8 is a cross-sectional view illustrating a stencil mask taken along a line V-V′ in FIG. 5;

FIGS. 9A to 9D are a cross-sectional views for describing a method of spreading a resin using the resin spread device of FIG. 6;

FIG. 10 is a cross-sectional view illustrating a resin spread device in accordance with example embodiments of the present invention;

FIG. 11 is a plane view illustrating the resin spread device having a stencil mask of FIG. 10; and

FIGS. 12A to 12F are a cross-sectional views for describing a method of spreading a resin using the resin spread device of FIG. 10.

### DETAILED DESCRIPTION OF THE INVENTION

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals generally refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the apparatus in use or operation in addition to the orientation depicted in the figures. For example, if the apparatus in the figures is turned over, elements described as “below” or “beneath” other elements or features would then be oriented “above” the other elements or features. Thus, the example term “below” can encompass both an orientation of above and below. The apparatus may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of an apparatus and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When applying resin the thickness of the resin is required to be uniform. When the thickness of the resin is not uniform, an electric device may deteriorate durability and performance. Thus, uniformity of the spread resin is important.

However, when the resin is spread by using a conventional resin spread device, it is not easy to spread the resin uniformly. For example, the resin has a viscosity. In mask stencil process, when a squeeze (which may be referred to as a print head) that makes contact with an upper surface of the resin is transported, a portion of the resin having the viscosity may be transported with the squeeze. In this case, a thickness of the resin may be gradually increased during the processing time.

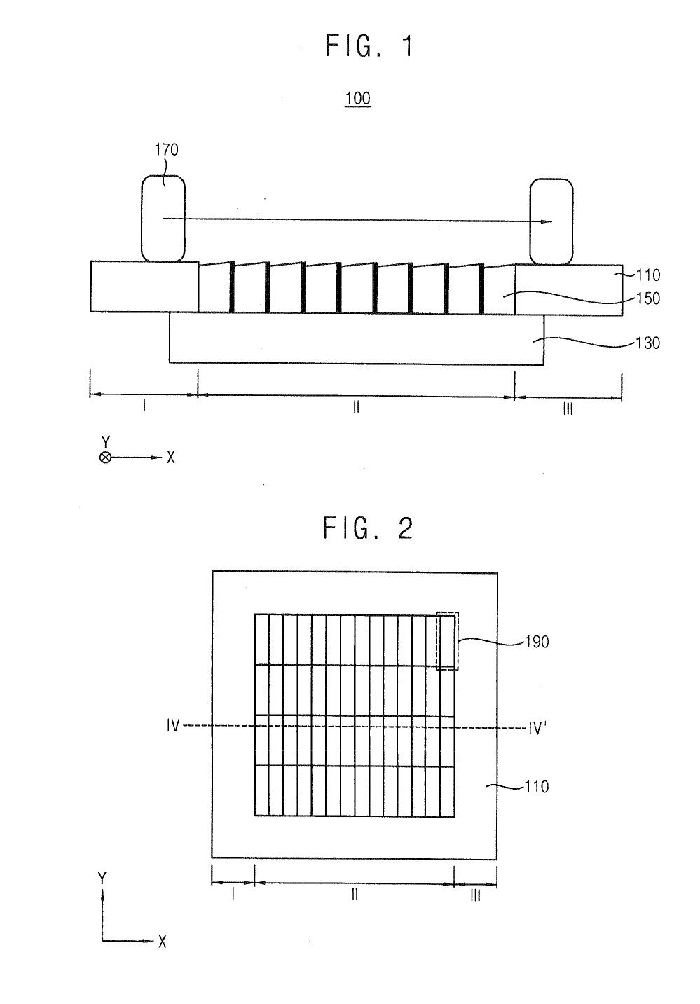

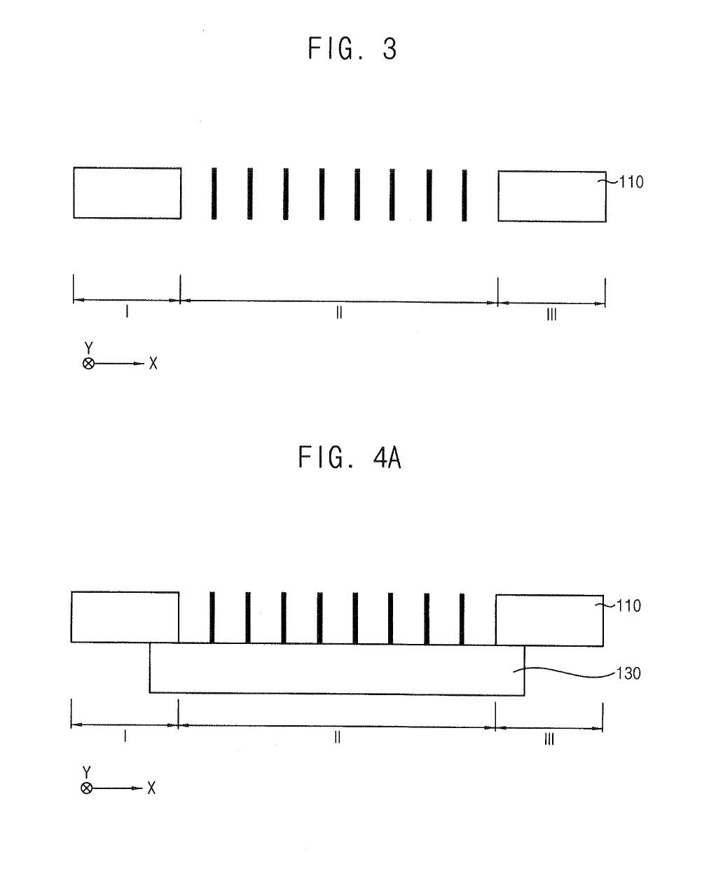

FIG. 1 is a cross-sectional view illustrating a resin spread device in accordance with example embodiments of the present invention, FIG. 2 is a plane view illustrating the resin spread device having a stencil mask of FIG. 1, and FIG. 3 is a cross-sectional view illustrating a stencil mask taken along a line IV-IV′ in FIG. 2.

Referring to FIGS. 1 through 3, a resin spread device 100 may include a substrate 130, a first member 110, a resin 150 and a second member 170.

The substrate 130 may include a glass-based material, a plastic-based material or the like. For example, the substrate 130 may include a glass substrate, a quartz substrate, a polymer resin substrate, or the like. In example embodiments, the substrate 130 may include a display panel. For example, the resin 150 may be spread on the display panel, and a tempered glass may be disposed on the resin.

The first member 110 may be disposed on the substrate 130. As illustrated in FIG. 2, the first member 110 may include a first region I, a second region II and a third region III, and the second region II may be surrounded by the first region I and the third region III. The first member 110 may include a plurality of openings 190 where is disposed on the second region II and an edge member where is disposed on the first region I and the third region III. The edge member may surround a plurality of the openings 190. As illustrated in FIG. 3, the openings 190 is disposed on the second region II of the first member 110, and the edge member is disposed on the first region I and the third region III of the first member 110. The edge member surrounds the openings 190.

The first member 110 may include a steel use stainless (SUS), an aluminum (Al). Since the first member 110 may adhere to the resin 150, the first member 110 may perform a fluorine (F) coating. In example embodiments, the first member 110 may include a stencil mask.

The resin 150 may be filled in the opening 190. A length of each opening 190 in an X-direction is shorter than a length of the opening 190 in a Y-direction, and the X-direction and the Y-direction are substantially perpendicular. The opening 190 may have a rectangular shape. As a length of the X-direction is decreased, a uniformity of the thickness is may be improved. A plurality of the openings 190 may include a mesh structure on the second region II. A lower surface of the mesh structure may make contact with an upper surface of the substrate 130.

The resin 150 may disposed in a plurality of the openings 190. The resin 150 may include an oligomer, a urethane acrylate, a monomer, a photoinitiator, a solvent, a ketone, or the like. In example embodiments, the resin 150 may include a photopolymer resin. The photopolymer resin may have a high transmittance, an adhesion function, and a viscosity of the photopolymer resin may be about 3,000 centipoise (CPS) to about 40,000 CPS.

Referring again to FIG. 1, the resin 150 is disposed in the opening 190, an upper surface of the resin 150 may have an inclined surface. An upper surface may incline toward the X-direction. The number of the opening 190 and the number of the upper surface of the resin 150 are substantially the same.

The second member 170 may be disposed on the first region I of the first member 110. The second member 170 may be transported from the first region I through the second region II of the first member 110 to the third region III of the first member 110. Accordingly, the second member 170 may pass toward the X-direction. Substantially, the second member 170 may pass by spacing apart from the first member 110. A distance between the first member 110 and the second member 170 may be about 5 Å to about 20 Å.

The second member 170 may include a steel use stainless (SUS), an aluminum (Al). Since the second member 170 may adhere to the resin 150, the second member 170 may perform a fluorine (F) coating. In example embodiments, the second member 170 may include a squeeze. When the second member 170 passes toward the X-direction with the resin 150, a lower surface of the second member 170 may pass by contacting an upper surface of the resin 150. As a moving distance of the second member 170 increases, a thickness of the resin 150 may be increased. The moving distance means a distance that the resin 150 is spread toward the X-direction or an opening region (i.e., the second region II) of the X-direction on the first member 110.

For example, when the first member 110 has not the mesh structure (e. g., the first member 110 has one opening, and then the number of an upper surface of the resin 150 is one), as a moving distance of the second member 170 increases, a thickness of the resin 150 may be increased, and then the uniformity of a thickness of the resin 150 is decreased. Otherwise, when the first member 110 has the mesh structure (the first member 110 has a plurality of the openings), the moving distance capable of increasing the inclined surface may be decreased by a plurality of the openings 190, and then the uniformity of a thickness of the resin 150 is improved. As a result, having an equilibrium state (planar surface state) in the large range (in case of one opening) takes a long time, and it is not easy. When the first member 110 has a plurality of the openings 190, the resin 150 may readily approach the equilibrium state in a plurality of the small ranges (i.e., a plurality of the openings 190).

Accordingly, when the resin 150 is spread on the substrate 130 by using first member 110 having a plurality of the rectangular openings 190, the resin spread device 100 may improve the uniformity of the thickness of the resin 150.

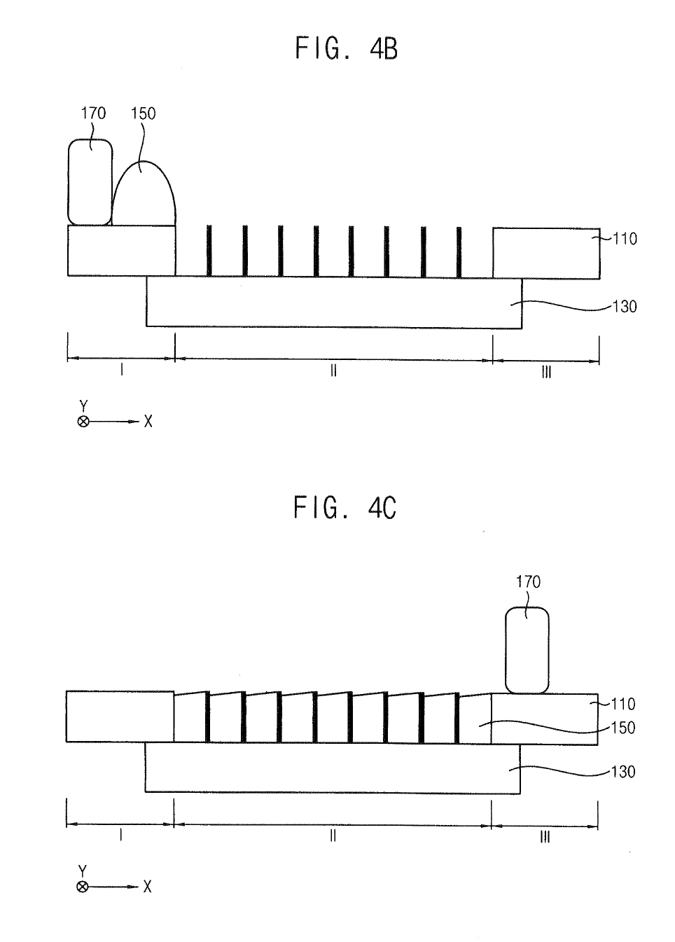

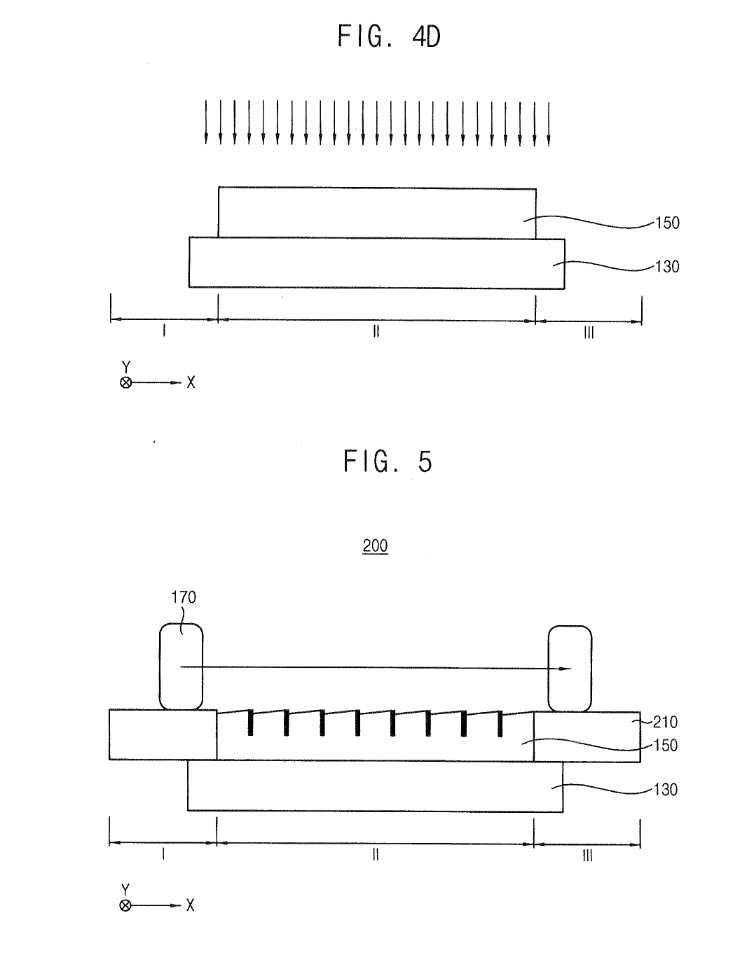

FIGS. 4A to 4D are a cross-sectional views for describing a method of spreading a resin using the resin spread device of FIG. 1.

Referring to FIG. 4A, a first member 130 may be disposed on a substrate 110.

Referring to FIG. 4B, a second member 170 and a resin 150 may disposed on a first region I of the first member 110. The resin 150 may make contact with the first member 110. The second member 170 may be disposed by spacing apart from the first member 110. A distance of the first member 110 and the second member 170 may be about 5 Å to 20 Å.

Referring to FIG. 4C, the second member 170 with a resin 150 may be transported from a first region I through a second region to a third region III, and may fill the resin 150 in an opening 190 of the first member 110. The second member 170 may pass toward the X-direction. After the second member 170 arrives at the third region III on the first member 110, the resin 150 may be disposed in the opening 190, and then an upper surface of the resin 150 may have an inclined surface. The upper surface may incline toward the X-direction. The number of the opening 190 and the number of the upper surface of the resin 150 are substantially the same.

Referring to FIG. 4D, after the first member 110 and the second member 170 where are disposed on the substrate 130 may be removed, the resin 150 may fill a space that is generated by removing the first member 110 (e. g., the characteristic of the resin 150 such ad a liquid). Thus, the uniformity of a thickness of the resin 150 may be improved. The following, the resin 150 having a uniform thickness may cure by irradiating the ultra violet (UV).

FIG. 5 is a cross-sectional view illustrating a resin spread device in accordance with example embodiments of the present invention.

The resin spread device 200 illustrated in FIG. 5 may have a configuration substantially the same as or substantially similar to that of the resin spread device 100 described with reference to FIGS. 1 except a mesh structure of a first member 210.

Referring to FIG. 5, a resin spread device 200 may include a substrate 130, a first member 210, a resin 150 and a second member 170. The first member 210 may be disposed on the substrate 130. The first member 210 may include a first region I, a second region II and a third region III, and the second region II may be surrounded by the first region I and the third region III. The first member 210 may include a plurality of openings where is disposed on the second region II and an edge member where is disposed on the first region I and the third region III. The edge member may surround a plurality of the openings. The openings may be disposed on the second region II of the first member 210, and the edge member may be disposed on the first region I and the third region III of the first member 210. The edge member surrounds the openings.

The first member 210 may include a steel use stainless (SUS), an aluminum (Al). Since the first member 210 may adhere to the resin 150, the first member 210 may perform a fluorine (F) coating. In example embodiments, the first member 210 may include a stencil mask.

The resin 150 may be filled in the opening. A length of each opening 190 in an X-direction is shorter than a length of the opening 190 in a Y-direction, and the X-direction and the Y-direction are substantially perpendicular. The opening may have a rectangular shape. As a length of the X-direction is decreased, a uniformity of the thickness is may be improved. A plurality of the openings may include a mesh structure on the second region II. A lower surface of the mesh structure may not make contact with an upper surface of the substrate 130 (i.e., a lower surface of the mesh structure may be spaced apart from the substrate 130.).

The resin 150, the resin 150 and the second member 170 are explained to FIGS. 1 to 3, and further repetitive explanation concerning the above elements will be omitted.

Accordingly, when the resin 150 is spread on the substrate 130 by using first member 210 having a plurality of the rectangular openings, the resin spread device 200 may improve the uniformity of the thickness of the resin 150.

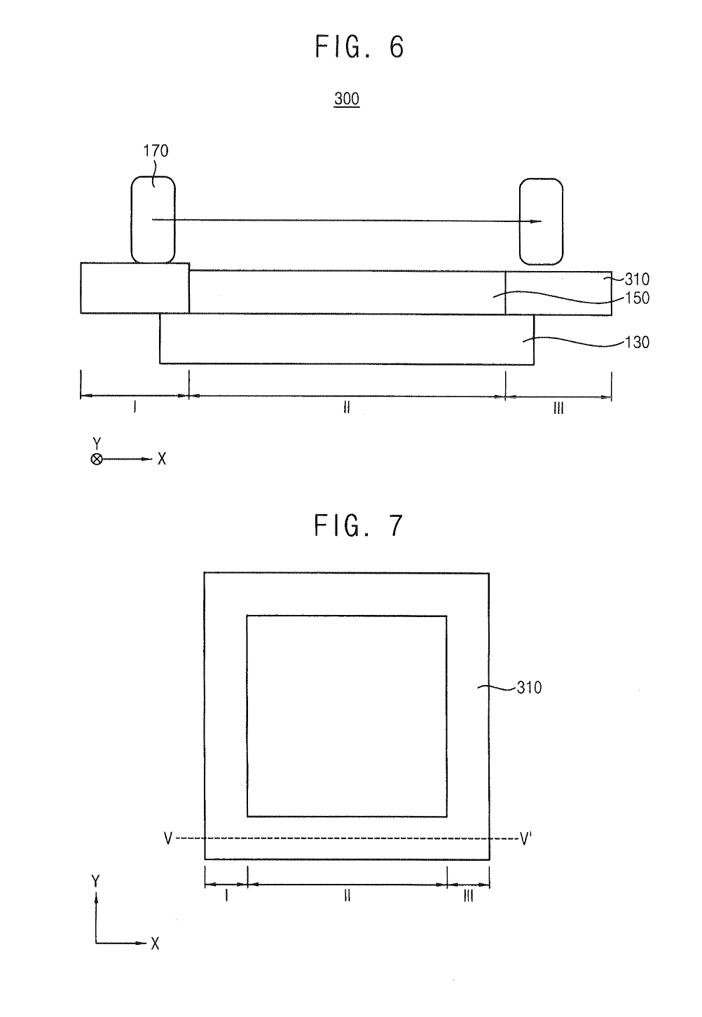

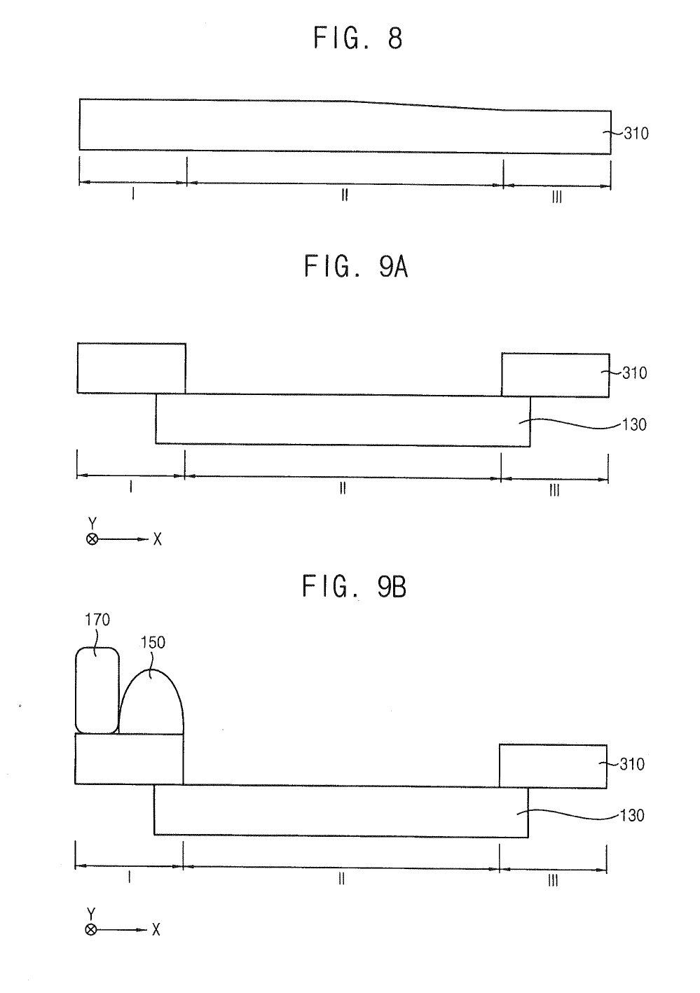

FIG. 6 is a cross-sectional view illustrating a resin spread device in accordance with example embodiments of the present invention, FIG. 7 is a plane view illustrating the resin spread device having a stencil mask of FIG. 6, and FIG. 8 is a cross-sectional view illustrating a stencil mask taken along a line V-V′ in FIG. 5.

Referring to FIGS. 6 through 8, a resin spread device 300 may include a substrate 130, a third member 310, a resin 150 and a second member 170.

The substrate 130 may include a glass-based material, a plastic-based material or the like. For example, the substrate 130 may include a glass substrate, a quartz substrate, a polymer resin substrate, or the like. In example embodiments, the substrate 130 may include a display panel. For example, the resin 150 may be spread on the display panel, and a tempered glass may be disposed on the resin.

The third member 310 may be disposed on the substrate 130. As illustrated in FIG. 7, the third member 310 may include a first region I, a second region II and a third region III, and the second region II may be surrounded by the first region I and the third region III. The third member 310 may include an opening where is disposed on the second region II and an edge member where is disposed on the first region I and the third region III. The edge member may surround the opening.

As illustrated in FIG. 8, a thickness of the edge member on the first region I may be thicker than a thickness of the edge member on the third region III. A difference between a thickness of the third member 310 on first region I and a thickness of the third member 310 on third region III may be about 10 Å to about 100 Å. The edge member of the second region II may include a planar surface and an inclined surface. A thickness of the planar surface and a thickness of the edge member on the first region I may be substantially the same. The inclined surface may be formed by a height difference between a thickness of the planar surface and a thickness of the edge member on the third region III.

The third member 310 may include a steel use stainless (SUS), an aluminum (Al). Since the third member 310 may adhere to the resin 150, the third member 310 may perform a fluorine (F) coating. In example embodiments, the third member 310 may include a stencil mask.

The resin 150 may be disposed in the opening. The resin 150 may include an oligomer, a urethane acrylate, a monomer, a photoinitiator, a solvent, a ketone, or the like. In example embodiments, the resin 150 may include a photopolymer resin. The photopolymer resin may have a high transmittance, an adhesion function, and a viscosity of the photopolymer resin may be about 3,000 centipoise (CPS) to about 40,000 CPS.

The second member 170 may be disposed on the first region I of the third member 310. The second member 170 may be transported from the first region I through the second region II to the third region III. Substantially, the second member 170 may pass by spacing apart from the third member 310. A distance between the third member 310 and the second member 170 may be about 5 Å to about 20 Å.

The second member 170 may include a steel use stainless (SUS), an aluminum (Al). Since the second member 170 may adhere to the resin 150, the second member 170 may perform a fluorine (F) coating. In example embodiments, the second member 170 may include a squeeze. When the second member 170 passes along with an upper surface of the third member 310 with the resin 150, a lower surface of the second member 170 may pass by contacting an upper surface of the resin 150. As a moving distance of the second member 170 increases, a thickness of the resin 150 may be increased. The moving distance means a distance that the resin 150 is spread or an opening region (i.e., the second region II) of the third member 310.

For example, when the third member 310 has not the edge members (i.e., the edge members on the first region I and on the third region III), as a the second member 170 and the resin 150 may transported from the first region I through the second region II to the third region III, a thickness of the resin 150 may be gradually increased. Thus, the uniformity of a thickness of the resin 150 is decreased. Otherwise, when the third member 310 has the edge members (i.e., the edge members on the first region I and on the third region III), the inclined surface (descent inclined surface of the second region II) that is generated by a height difference between the edge members on the first region I and on the third region III may decrease the resin 150 that is stacked in front of the second member 170 (i.e., a distance between the second member 170 and the resin 150 may be gradually increased at the descent inclined surface of the second region II.). Thus, a thickness of the resin 150 is not increased, and the resin 150 may readily approach the equilibrium state (planar surface state).

Accordingly, when the third member 310 has the edge members (i.e., the edge members on the first region I and on the third region III), the resin spread device 300 may improve the uniformity of the thickness of the resin 150.

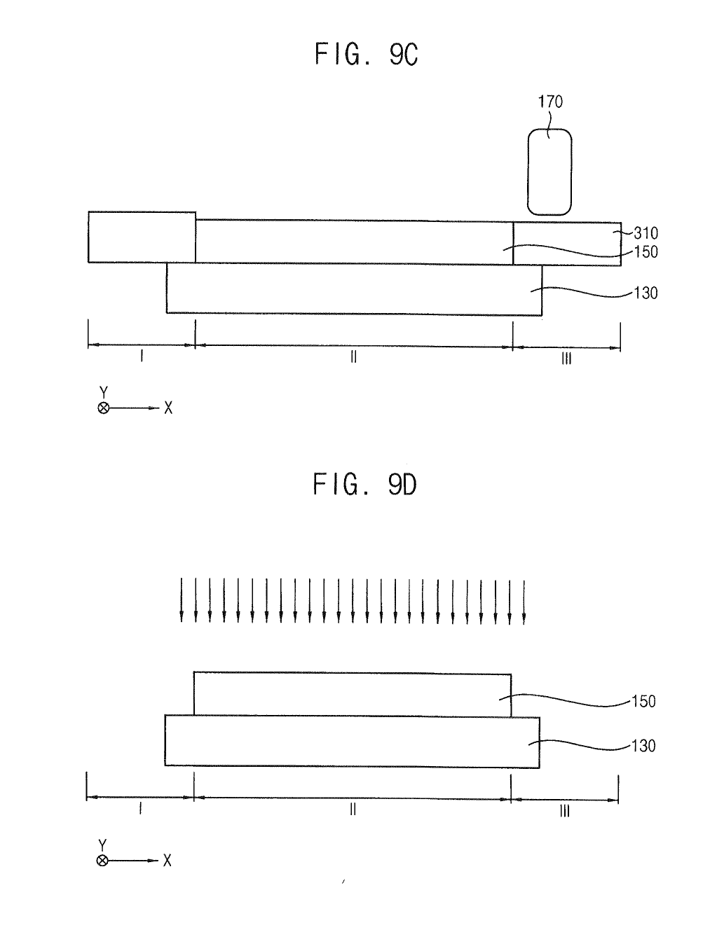

FIGS. 9A to 9D are a cross-sectional views for describing a method of spreading a resin using the resin spread device of FIG. 6.

Referring to FIG. 9A, a third member 310 may be disposed on a substrate 130.

Referring to FIG. 9B, a second member 170 and a resin 150 may disposed on a first region I of the third member 310. The resin 150 may make contact with the third member 310. The second member 170 may be disposed by spacing apart from the third member 310. A distance of the third member 310 and the second member 170 may be about 5 Å to 20 Å.

Referring to FIG. 9C, the second member 170 with a resin 150 may be transported from a first region I through a second region to a third region III, and may fill the resin 150 in an opening of the third member 310. When the second member 170 with the resin 150 is transported from the first region I through the second region to the third region III, a distance between the second member 170 and the resin 150 may be gradually increased at the descent inclined surface of the second region II. The resin 150 that is stacked in front of the second member 170 may be decreased. The uniformity of the thickness of the resin 150 may be improved.

Referring to FIG. 9D, the third member 310 and the second member 170 where are disposed on the substrate 130 may be removed. The following, the resin 150 having a uniform thickness may cure by irradiating the ultra violet (UV).

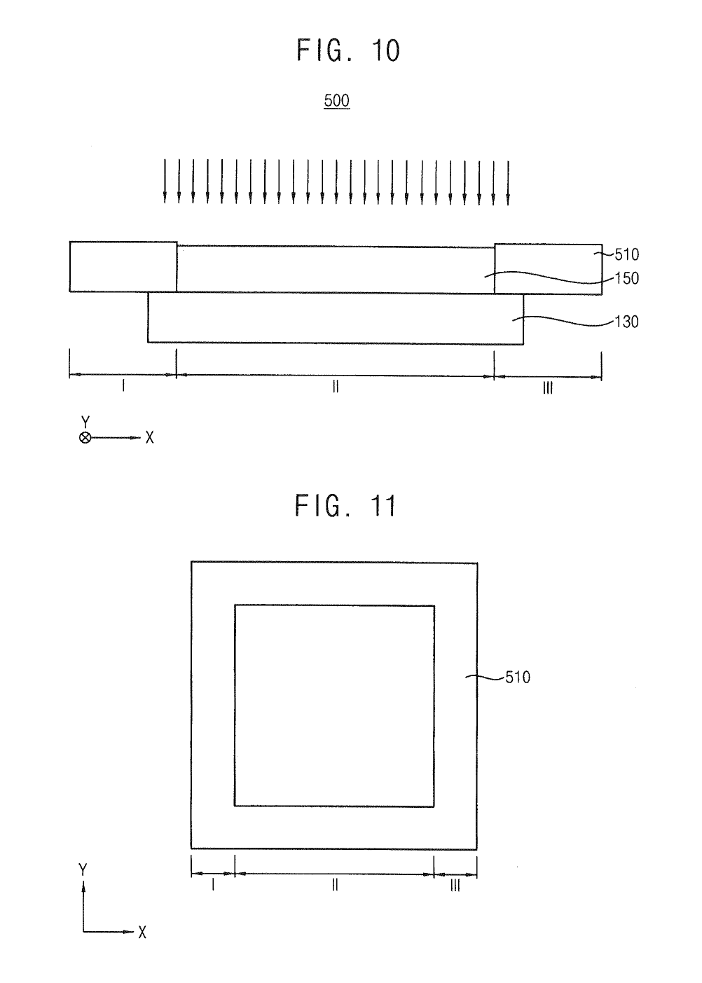

FIG. 10 is a cross-sectional view illustrating a resin spread device in accordance with example embodiments of the present invention, and FIG. 11 is a plane view illustrating the resin spread device having a stencil mask of FIG. 10.

Referring to FIGS. 10 and 11, a resin spread device 500 may include a substrate 130, a fourth member 510, a resin 150 and a second member 170.

The substrate 130 may include a glass-based material, a plastic-based material or the like. For example, the substrate 130 may include a glass substrate, a quartz substrate, a polymer resin substrate, or the like. In example embodiments, the substrate 130 may include a display panel. For example, the resin 150 may be spread on the display panel, and a tempered glass may be disposed on the resin.

The fourth member 510 may be disposed on the substrate 130. As illustrated in FIG. 11, the fourth member 510 may include a first region I, a second region II and a third region III, and the second region II may be surrounded by the first region I and the third region III. The fourth member 510 may include an opening where is disposed on the second region II and an edge member where is disposed on the first region I and the third region III. The edge member may surround the opening.

The fourth member 510 may include a steel use stainless (SUS), an aluminum (Al). Since the fourth member 510 may adhere to the resin 150, the fourth member 510 may perform a fluorine (F) coating. In example embodiments, the fourth member 510 may include a stencil mask.

The resin 150 may be disposed in the opening. The resin 150 may include an oligomer, a urethane acrylate, a monomer, a photoinitiator, a solvent, a ketone, or the like. In example embodiments, the resin 150 may include a photopolymer resin. The photopolymer resin may have a high transmittance, an adhesion function, and a viscosity of the photopolymer resin may be about 3,000 centipoise (CPS) to about 40,000 CPS.

The second member 170 may be disposed on the first region I of the fourth member 510. The second member 170 may be transported from the first region I through the second region II to the third region III. Substantially, the second member 170 may pass by spacing apart from the fourth member 510. A distance between the fourth member 510 and the second member 170 may be about 5 Å to about 20 Å.

The second member 170 may include a steel use stainless (SUS), an aluminum (Al). Since the second member 170 may adhere to the resin 150, the second member 170 may perform a fluorine (F) coating. In example embodiments, the second member 170 may include a squeeze. When the second member 170 passes along with an upper surface of the fourth member 510 with the resin 150, a lower surface of the second member 170 may pass by contacting an upper surface of the resin 150. As a moving distance of the second member 170 increases, a thickness of the resin 150 may be increased. The moving distance means a distance that the resin 150 is spread or an opening region (i.e., the second region II) of the fourth member 510.

When the second member 170 with the resin 150 is transported from the first region I through the second region II to the third region III, a thickness of the resin 150 may be gradually increased by the resin 150 that is stacked in front of the second member 170. Thus, the uniformity of a thickness of the resin 150 is decreased. In this case, after the resin 150 having a low viscosity is spread on the substrate 130, an upper surface of the resin 150 having the low viscosity may be leveled by gravity.

Accordingly, when the resin 150 having the low viscosity is spread on the substrate 130, the resin spread device 500 may improve the uniformity of the thickness of the resin 150.

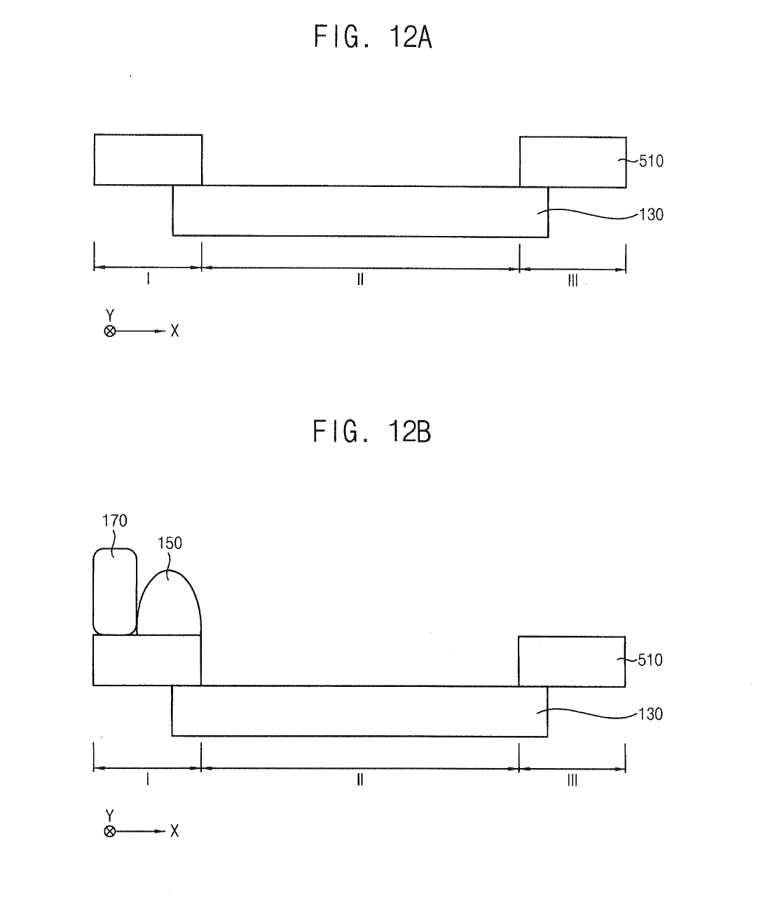

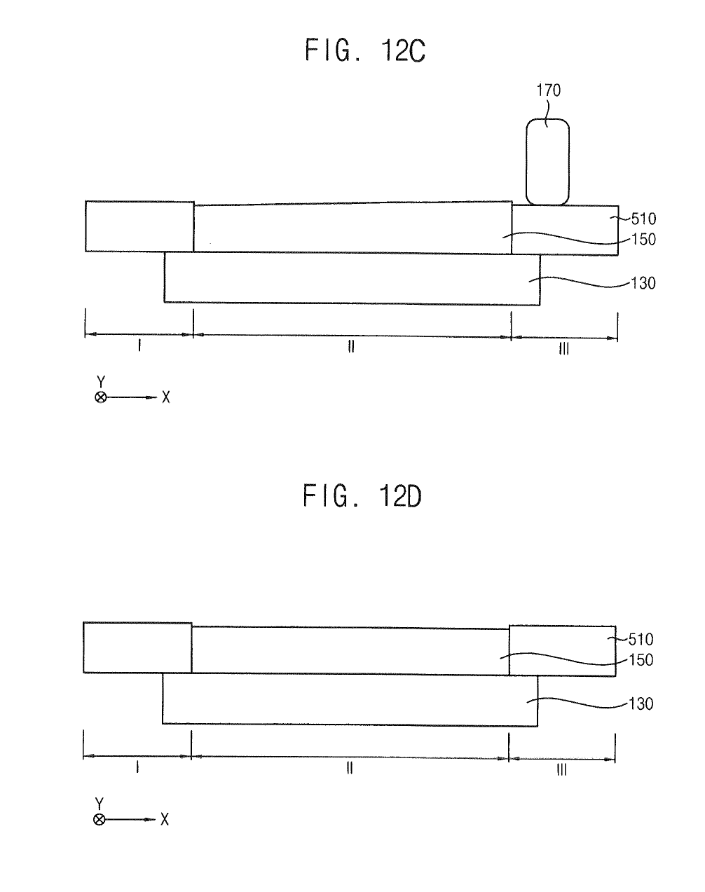

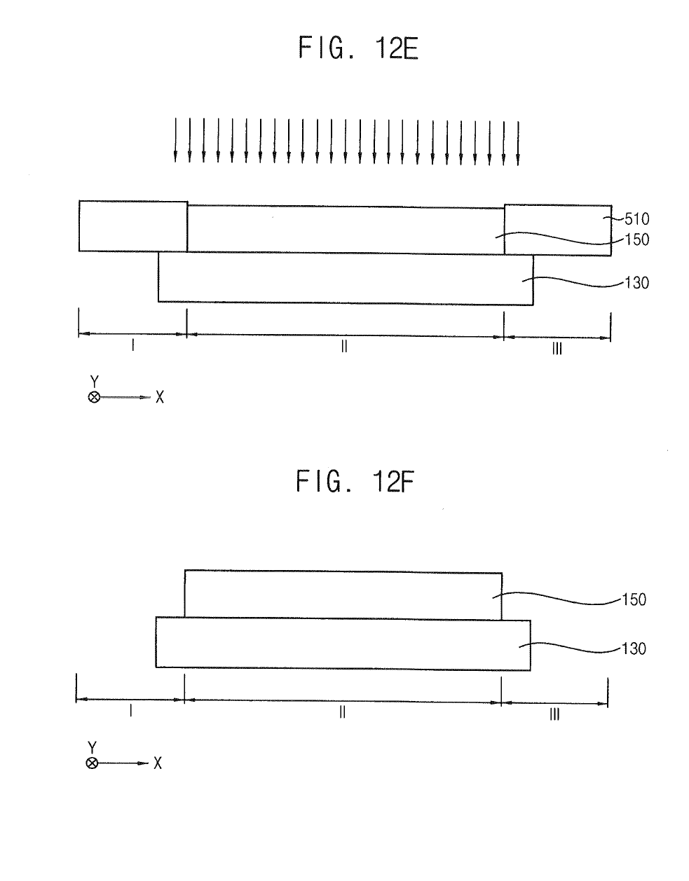

FIGS. 12A to 12F are a cross-sectional views for describing a method of spreading a resin the resin spread device of FIG. 10.

Referring to FIG. 12A, a fourth member 510 may be disposed on a substrate 130.

Referring to FIG. 12B, a second member 170 and a resin 150 may disposed on a first region I of the fourth member 510. The resin 150 may make contact with the fourth member 510. The second member 170 may be disposed by spacing apart from the fourth member 510. A distance of the t4 and the second member 170 may be about 5 Å to 20 Å. The resin 150 may have a low viscosity.

Referring to FIG. 12C, the second member 170 with a resin 150 having the low viscosity may be transported from a first region I through a second region to a third region III, and may fill the resin 150 having the low viscosity in an opening of the fourth member 510. When the second member 170 with the resin 150 having the low viscosity is transported from the first region I through the second region to the third region III, the resin 150 having the low viscosity may be stacked in front of the second member 170, and then a thickness of the resin 150 having the low viscosity may be gradually increased.

Referring to FIG. 12D, an upper surface of the resin 150 having the low viscosity may be leveled by gravity. When the resin 150 having the low viscosity and the second member 170 are transported from the first region I through a second region II to the third region III, the uniformity of the thickness of the resin 150 having the low viscosity may be improved.

Referring to FIG. 12E, the second member 170 where are disposed on the substrate 130 may be removed. The following, the resin spread device 300 may cure by irradiating the ultra violet (UV).

Referring to FIG. 12F, the fourth member 510 may be removed.

The present invention may be applied to the entire system device using the resin spread. For example, the present may be applied to the mobile phone, the smart phone, the laptop computer, the tablet computer, the personal digital assistant; PDA, the portable multimedia player; PMP, the digital camera, the music player, the portable game console, the navigation, or the like.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims.

Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. A resin spread device, comprising:
a substrate;
a first member disposed on the substrate, the first member including a first region, a second region and a third region, the first region and the third region surrounding the second region, a plurality of rectangular openings disposed in the second region, and the first member surrounding the openings;
a resin disposed in the openings; and
a second member disposed on the first region, and being transported from the first region through the second region to the third region.

2. The resin spread device of claim 1, wherein a length of each opening in an X-direction is shorter than a length of the opening in a Y-direction, and the X-direction and the Y-direction are substantially perpendicular.

3. The resin spread device of claim 1, wherein the rectangular openings comprise a mesh structure.

4. The resin spread device of claim 3, wherein a lower surface of the mesh structure makes contact with the substrate.

5. The resin spread device of claim 3, wherein a lower surface of the mesh structure is spaced apart from the substrate.

6. The resin spread device of claim 1, wherein an upper surface of the resin disposed in the opening is inclined with respect to the substrate.

7. The resin spread device of claim 1, wherein an upper surface of the resin is positioned higher in a passing direction of than the second member.

8. A method of spreading a resin, the method comprising:
disposing a first member on a substrate;
disposing a second member and a resin on a first region of the first member;
filling the resin in openings of the first member while the second member and the resin are transported from the first region through a second region of the first member to a third region of the first member; and
removing the first member and the second member to cure the resin.

9. The method of claim 8, wherein a length of each opening in an X-direction is shorter than a length of the opening in a Y-direction, and the X-direction and the Y-direction are substantially perpendicular.

10. The method of claim 8, wherein a plurality of rectangular openings comprise a mesh structure.

11. The method of claim 8, wherein an upper surface of the resin in the opening is inclined with respect to the substrate.

12. The method of claim 11, wherein the upper surface of the resin is higher in a passing direction of the second member.

13. A resin spread device, comprising:
a substrate;
a third member disposed on the substrate, the third member including a first region, a second region and a third region, the first region and the third region surrounding the second region, the third member including an opening disposed in the second region, the third member surrounding the opening, and a height of the third member in the first region being different from a height of the third member in the third region;
a resin disposed in the opening; and
a second member disposed in the first region of the third member, and being transported from the first region through the second region to the third region.

14. The resin spread device of claim 13, wherein a thickness of the third member in the first region is thicker than a thickness of the third member in the third region.

15. The resin spread device of claim 14, wherein the second region of the third member comprises a planar surface and an inclined surface.

16. The resin spread device of claim 15, wherein a thickness of the planar surface and the thickness of the third member in the first region are substantially the same, and the inclined surface connects the planar surface to the third member in the third region.

17. A resin spread device, comprising:
a substrate;
a fourth member disposed on the substrate, the fourth member including a first region, a second region and a third region, the first region and the third region surrounding the second region, the fourth member including an opening disposed in the second region, and the fourth member surrounding the opening;
a resin disposed in the opening; and
a second member disposed in the first region, the second member being transported from the first region through the second region to the third region.

18. The resin spread device of claim 17, wherein the resin comprises a low viscosity.

19. The resin spread device of claim 18, wherein an upper surface of the resin including the low viscosity is leveled by a gravity.

20. The resin spread device of claim 1, wherein the first region, the second region and the third region are separate distinct regions,
wherein, the first region is immediately adjacent to the second region and the second region is immediately adjacent to the third region,
wherein the second region is between the first and second regions, and
wherein no intervening regions or structures exist between the first, second and third regions.
